(19) United States
(12) Patent Application Publication
(10) Pub. No.: US 2006/0224992 A1
(43) Pub. Date: Oct. 5, 2006

(54) Graphical user interface management

(75) Inventors: Robert Rossi, Bellevue, WA (US); Trent Swanson, Mill Creek, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/097,490

(22) Filed: Apr. 1, 2005

(51) Int. Cl. G06F 17/00; G06F 9/00

(52) U.S. Cl. 715/781

(57) ABSTRACT

A graphical user interface (GUI) is presented on a display including a parent window and a number of child windows rendered within the parent window according to a display scheme. When the size of one of the child windows is changed, the size of one or more of the other child windows is changed, so that the display scheme is maintained.

### BACKGROUND

Handheld computing devices, such as Personal Digital Assistants (PDAs), Pocket PCs, cell phones, handheld gaming systems, handheld electronic testing equipment, and the like, often include a display. Many of these handheld computing devices provide a graphical user interface (GUI) on their displays. Unfortunately, due to the small size of the displays in these handheld computing devices, graphical user interfaces used on larger displays, such as displays used with desktop computers, are often not optimal for these handheld devices. This problem is acerbated when the GUI includes multiple windows.

### BRIEF DESCRIPTIONS OF THE DRAWINGS

FIG. 1 illustrates one example of a computing device including a display on which is rendered a graphical user interface (GUI).

FIG. 2 illustrates the display and GUI of FIG. 1 and one example of GUI management module for controlling the GUI.

FIG. 3 illustrates one example of a child window module of the GUI management module of FIG. 2.

FIG. 4 illustrates one example of a window management module of the GUI management module of FIG. 2.

FIG. 5 illustrates one example of an operational flow for controlling the GUI of FIGS. 1 and 2.

FIG. 6 illustrates another example of an operational flow for controlling the GUI of FIGS. 1 and 2.

FIG. 7 illustrates another example of an operational flow for controlling the GUI of FIGS. 1 and 2.

### DESCRIPTION

The following description sets forth, among other things, implementations of various technologies and techniques that may be used in, or in conjunction with, presenting and managing a Graphical User Interface (GUI) on a display of computing device.

In accordance with some of the implementations described herein, a GUI is rendered on a display of a computing device in the form of parent window having a defined child window presentation area. Rendered within the child window presentation area are a number of child windows. Each child window within the child window presentation area is associated with a particular process. As used here, a process may be any program, process, service, or the like, which accepts and/or delivers information via a child window and/or may otherwise be interacted with and/or controlled by a user via a child window. That is, each child window presents a GUI for its associated process. For example, one child window may present a GUI for a database program, another child window may present a GUI for automatic stock quotation service, another child window may present a GUI for an inbox of an email program, and yet another child window GUI may present a GUI for a search function in the email program, etc.

Each of the child windows may be displayed in one of a number of visual/functional modes. That is, at any given time, a child window will be displayed in accordance with one visual/functional mode, selected from a number of visual/functional modes available for that child window. Each mode may specify such things as the number and placement of windows controls (e.g., toolbars, buttons, etc.) in the child window, the format and type of information the child window will display, the size, or range of sizes, of the child window, whether the size of the child window is variable, as well as the functionality that will be made available to a user via the child window, etc. For example, a child window for an email program may have a first mode that displays a list of received email messages, a second mode that displays various window controls for changing operating parameters of the email program, and a third mode that displays a selectable list of email messages and a scrollable window for viewing the contents of a selected single email message, etc.

In one implementation, the child windows are arranged within the child window presentation area in accordance with a predetermined display scheme. In general, a display scheme specifies a required spatial relationship between the child windows within the child window presentation area. For example, and without limitation, in accordance with one display scheme, referred to herein as the “full display area scheme,” the child windows are arranged within the child window presentation area in a manner such that all available real estate within the child window presentation area is fully occupied by the child windows presented therein, and such that none of the child windows overlap one another.

When the size of one of the child windows is changed, such as when the mode of an child window is changed, the size of one or more of the other child windows will need to be adjusted, so that present display scheme is maintained. For example, in accordance with the full display area scheme, when the size of one child window is changed, the size of one or more of the other child windows is then changed, such that all of the child windows continue to be displayed in a non-overlapping manner that fully occupies the child window presentation area.

In one implementation, the changing of the modes of the child windows such that a given display scheme is maintained is carried out by a window management module. In these implementations, the window management module determines in which mode each of the child windows is to be, so as to maintain a particular display scheme.

In some implementations, the window management module maintains a display scheme using a “child window ranking order.” As used herein, a “child window ranking order” is a sequential ranking of the child windows based on some predetermined criteria. The child window ranking order specifies a relative order of importance for the child windows. This order of importance is then used in determining which, if any, child windows will have their modes changed in order to maintain a display scheme. For example, in one implementation, when it is determined that a child window needs to be transitioned to a mode requiring less display real estate, a child window having a low order of importance will preferably be transitioned to a mode requiring less display real estate, rather than a child window having a high order of importance.

In some implementations, the window management module maintains a display scheme using a “child window mode promotion/demotion sequence” for each of the child windows. As used herein, a “child window mode promotion/demotion sequence” is a sequential ordering of the modes of a given child window. Typically, although not necessarily, modes are ordered in a child window mode sequence according to how much display real estate each mode will require. When changing a child window from one mode to another, the child window is then transitioned from its current mode to either the next higher or lower mode in its mode sequence, depending on whether more or less display real estate is required.

In some implementations, the window management module maintains a display scheme using both the child window ranking order and the child window mode promotion/demotion sequence.

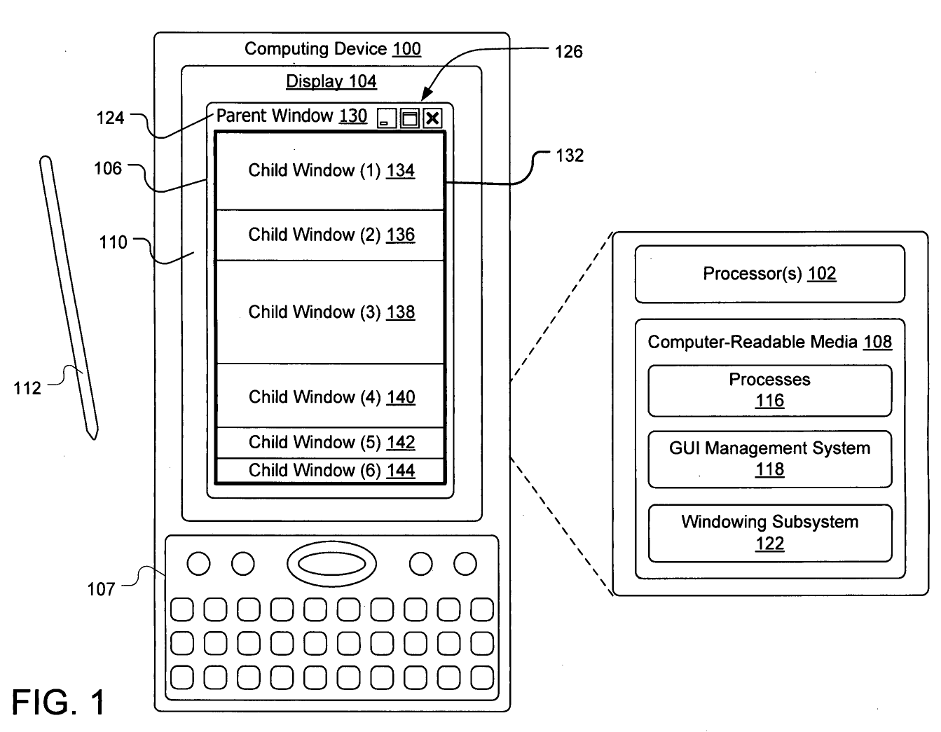

Turning now to FIG. 1, illustrated therein is one possible computing device 100 in which GUI presentation and management, as described herein, may be implemented. In particular, FIG. 1 illustrates a handheld computing device 100. It should be understood that while the following descriptions are made with respect to handheld computing device 100 illustrated in FIG. 1, GUI presentation and management, as described herein, may be implemented in any computing device, computing system, or the like, that includes or has accesses to appropriate software and hardware for presenting a GUI.

Examples, of other types of computing devices in which GUI presentation and management, as described herein, may be implemented include, without limitation, personal computers, microprocessor-based or programmable consumer or automotive electronics, network PCs, set top boxes, minicomputers, game consoles, mainframe computers, electronic testing equipment, etc. GUI presentation and management, as described herein, may also be implemented in a distributed computing environment, where the performance of operations and the storage of data may be distributed across processing devices that are linked through a communications network.

As shown in FIG. 1, computing device 100 includes a processor 102, a display 104 on which a GUI 106 is rendered, a control panel 107, and computer-readable media 108. Display 104 may either be physically integrated into computing device 100 or physically separate from computing device 100. In either case, display 104 will have appropriate mechanisms and functionality for displaying GUI 106. Display 104 may also include mechanisms, such as a touch screen, soft keys, stylus sensor, or the like, through which a user may interact with GUI 106. For example, as shown, display 104 includes a touch screen 110 and a stylus 112, which may be employed by a user to interact with various visual and functional elements presented in GUI 106 (e.g., windows, windows controls, etc.).

Control panel 107 includes a keyboard and various other user input mechanisms, which facilitate user interaction with GUI 106. In addition to display 104 and control panel 107, computing device 100 may include, or be operably connected to, other input devices (e.g., mouse, microphone, etc.) and output devices (e.g., speakers, printers, and other peripherals, etc.). Computing device 100 may also include communications connections to facilitate wireless or wire-based communication with other computers, computer networks, peripherals, input devices, and the like.

As used herein, computer-readable media 108 may be any media that can store or embody information that is encoded in a form that can be accessed and understood by a computer. Typical forms of computer-readable media include, without limitation, both volatile and nonvolatile memory, data storage devices including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

In the implementation illustrated in FIG. 1, computer-readable media 108 includes one or more processes 116, a GUI management module 118, and a windowing subsystem 122. In the various implementations described herein, processes 116, GUI management module 118, and windowing subsystem 122 comprise or are composed of software modules embodied in computer-readable media 108. Software modules may include or embody computer-executable instructions, and/or data, etc., in various forms and/or formats. Software modules may include various sub-modules, routines, programs, objects, components, data structures and the like that perform particular tasks or implement particular abstract data types.

While described herein as software modules embodied in computer-readable media 108 and executed on processor 102, it will be appreciated that processes 116, GUI management module 118 and windowing subsystem 122 may alternatively be implemented all or in part as hardware, firmware, or various combinations of software, hardware, and/or firmware. Additionally, although described herein as being implemented in computing device 100, in some implementations, any or all of processes 116, GUI management module 118, and windowing subsystem 122 may be implemented all or in part in a distributed computing environment, where the performance of operations and the storage of data may be distributed across processing devices that are linked through a communications network.

In general, windowing subsystem 122 handles various operations related to managing and presenting windows and window controls on display 104. Windowing subsystem 122 may handle such things as, without limitation, translating user interactions with computing device 100 and GUI 106 (e.g., keystrokes, stylus movements, and control selections, etc.) into messages for processes 116 and/or the operating system of computing device 100 (not shown), message queuing, creating and managing various aspects of GUI 106. For example, windowing subsystem 122 may define and manage typical visual elements and functional features of GUI 106, such as windows, windows controls, graphics, text, APIs and/or other resources.

Those skilled in the art will appreciate that there are a number of different types of windowing subsystems that provide or facilitate presentation of a GUI on a display. Typically, such windowing subsystems are a part of, or are otherwise associated with, an operating system. Some examples of operating systems that provide such windowing subsystems include, without limitation, various versions of the MICROSOFT® WINDOWS® operating system (e.g., WINDOWS® XP, WINDOWS® CE, etc.), various versions of the UNIX® operating system, and other operating systems. In some implementations, windowing subsystem 122 may be a part of, or are otherwise associated with, one of these windowing operating systems. In other implementations, windowing subsystem 122 may comprise other proprietary, nonproprietary, currently available or later developed windowing systems that are a part of, or separate from, an operating system.

Those skilled in the art will further appreciate that a windowing subsystem does not typically render the visual elements of a GUI directly on a display. Rather, computing devices typically include various hardware and/or software components (e.g., graphics cards, accelerators, etc.) that render the GUI on a display based on data received from a windowing subsystem or operating system.

As shown in FIG. 1, in accordance with one implementation, GUI 106 includes a parent window 130 having a defined child window presentation area 132. Rendered within child window presentation area 132 are a number of child windows 134-144. It should be noted that while six child windows 134-144 are shown in child window presentation area 132, fewer or more child windows may be presented in child window presentation area 132.

In some implementations, each child window 134-144 is associated with, and presents a GUI for, a particular process. As previously noted, and as used here, a process may be any program, process, service, or the like, which accepts and/or delivers information via a child window and/or may otherwise be interacted with and/or controlled by a user via a child window.

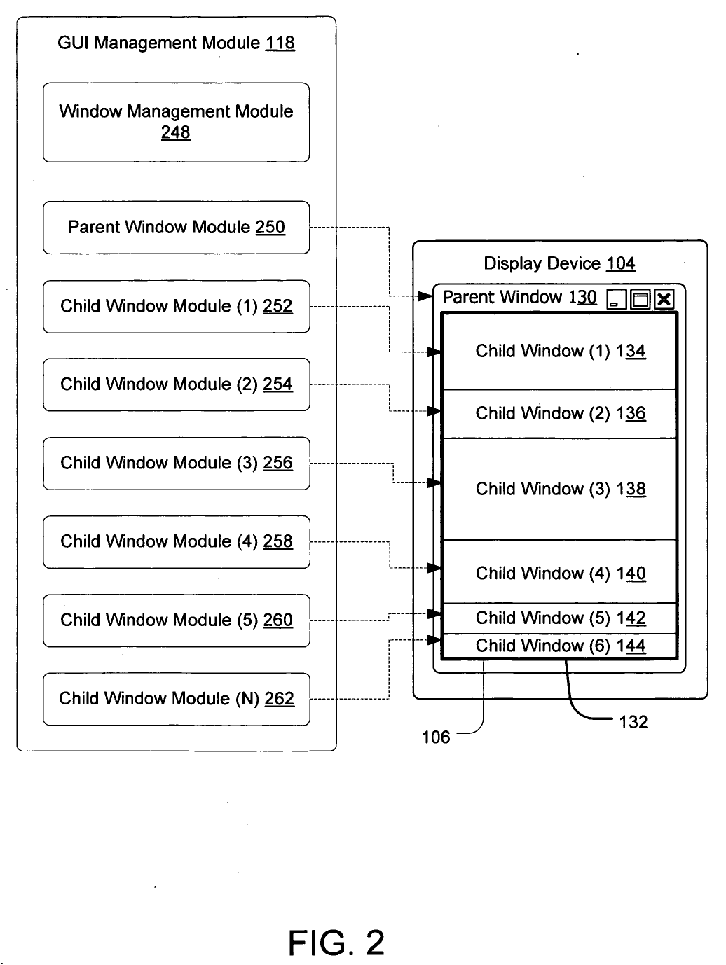

Parent window 130 may be displayed in various visual styles (e.g., window shape, border types, and colors, etc.) and may include any number of window controls. Examples of windows controls include, but are not limited to, toolbars, buttons, textboxes, dialog boxes, list boxes, combo boxes, edit boxes, check boxes, wizards, property sheets, radio buttons, calendars, progress bars, scrollbars, pallets, menus, tabs, carrots, sub-windows, etc. For example, in the implementation shown in FIG. 1, parent window 130 is rectangular in shape, includes a tool bar 124, and includes various window controls 126. In other implementations, parent window 130 may be other than rectangular in shape, have no toolbar or another type or types of toolbars, and may have other window controls. As described below, in some implementations, the visual and functional attributes of parent window 130 are defined by a parent window module 250 (FIG. 2).

Child window presentation area 132 comprises a visual region within parent window 130 wherein child windows 134-144 are rendered. Child window presentation area 132 may have various visual attributes or features, such as an exterior border or interior borders, or the like, separating child windows 134-144, etc. Conversely, child window presentation area 132 may have no visual attributes or features. As described below, in some implementations, the visual and functional attributes of child window presentation area 132, if any, are defined by parent window module 250 (FIG. 2).

In various implementations described herein, each child window 134-144 is displayed in accordance with one of a number of visual/functional modes associated with the child window. In general, each mode specifies the visual layout of the window for its associated child window. For example, a mode may specify the size, shape, and/or color of its associated child window, as well as the type, number, and/or arrangement of window controls within its associated child window.

Additionally, each mode may specify functionality or combinations of functionality that will be made accessible to a user via the window controls presented in its associated child window. A mode may specify how text or graphical information will be displayed in its associated child window. A mode may specify whether its associated child window is adjustable in size and, if the child window is adjustable, the manner in which the child window may be adjusted and a range of sizes for the adjustable window. A mode may specify whether its associated child window is user and/or system selectable. A mode may also specify whether a child window is to be hidden, i.e., not displayed. As described below, in some implementations, the modes of a child window are defined by child window modules (FIG. 2), which are a part of, or referenced by, GUI management system 118.

In some implementations, child windows 134-144 are arranged within child window presentation area 132 in accordance with a predetermined display scheme. In general, a display scheme specifies a required spatial relationship between child windows within child window presentation area 132. For example, and without limitation, a display scheme may specify whether or not child windows may overlap one another, whether or not child windows will be required to occupy an entire child window presentation area, whether child windows are to be arranged vertically or horizontally relative to one another in a child window presentation area, etc.

For example, in accordance with one display scheme, referred to herein as the “full display area scheme,” all child windows are arranged within an child window presentation area in a manner such that all available display real estate within child window presentation area 132 is fully occupied by the child windows, and such that none of the child windows overlap one another.

In accordance with another display scheme, referred to herein as the “tiling scheme,” all child windows are polygonal in shape and are arranged within a child window presentation area such that none of the child windows overlap.

In accordance with yet another display scheme, referred to herein as the “vertical rectangular tiling scheme,” all child windows are rectangular in shape and are arranged vertically within child window presentation area 132, such that none of the child windows overlap. FIG. 1 illustrates a vertical rectangular tiling scheme.

Those skilled in the art will appreciate that there are many possible combinations and arrangements of windows in various shapes and sizes that may be specified by a display scheme.

Typically, when the size of one or more child windows 134-144 is changed, such as when the mode of one of child window 134-144 is changed, the size of one or more of the other child windows will need to be adjusted, so that all of the child windows will continue to be displayed in accordance with the present display scheme. For example, in accordance with the vertical rectangular tiling scheme illustrated in FIG. 1, when the size of one child window 134-144 is changed, the size of one or more of the other child windows will need to be changed, so that all of child windows 134-144 continue to be displayed in a non-overlapping manner that fully occupies child window presentation area 132.

In accordance with some of the implementations described herein, it is the function of GUI management module 118 to maintain display schemes. As will be appreciated, the precise manner in which GUI management module 118 maintains a display scheme may vary, depending on such things as the type of display scheme that is being maintained, the type of windowing system that is being used, as well as other factors. However, in accordance with various implementations described herein, GUI management module 118 maintains display schemes, by changing, or instigating the changing of, the size and/or mode or modes of one or more child windows 134-144, such that the arrangement of child windows 134-144 in child window presentation area 132 conforms to the display scheme.

In accordance with some implementations, GUI management module 118 determines which child window or windows 134-144 should have their size and/or modes changed using a child window ranking order. In general, the child window ranking order specifies a preferred order for selecting child windows for mode changes.

Turning now to FIG. 2, shown therein is a block diagram illustrating various details of one particular implementation of GUI management module 118. As shown, GUI management module 118 includes or references a display scheme management module 248, a number (N) of child window modules 252-262, and a parent window module 250.

As shown in FIG. 2, each child window module 252-262 is associated with a single child window 134-144, and includes information that defines visual and/or functional characteristics of the child window associated with the child window module. For example, in one implementation, each child window module includes information that specifies all possible visual modes of the child window associated with the child window module. Furthermore, each child window module may include various data, data structures, and/or logic, used in defining the visual presentation of each of the possible modes. As described previously, in some implementations, this data and logic is used, all or in part, by windowing subsystem 122 in displaying a child window in the child window presentation area 132.

In some implementations, each child window module 252-262 includes or references computer-executable instructions embodying procedures, functions, routines, data, etc., (i.e., “code”) for specifying the rendering of its associated child windows. However, in the implementations that will now be described, each child window module 252-262 includes or references various data and or logic that is accessed and used by GUI management module 118 and/or windowing sub-system 122 in rendering child windows.

In general, parent window module 250 includes information that defines visual and/or functional characteristics of parent window 130. For example, in one implementation, parent window module 250 includes information that specifies functionality or combinations of functionality that will be made accessible to a user via window controls presented in parent window 130. Parent window module 250 may specify how text or graphical information will be displayed in parent window 250. Parent window module 250 may specify whether parent window 250 is adjustable in size and, if parent window 250 is adjustable, the manner in which parent window 250 may be adjusted. Parent window module 250 may further specify input methods, such as whether and how input from such things as a keyboard, a stylus and/or a mouse may be effectuated. Parent window module 250 may, of course, specify other visual and/or functional characteristics of parent window 130.

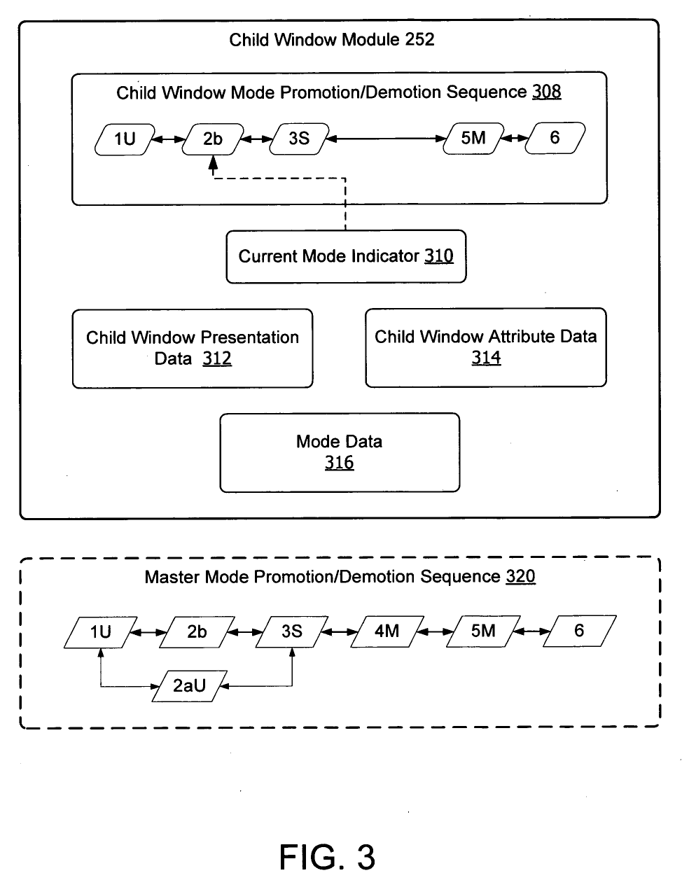

FIG. 3 illustrates one example implementation of child window module 252. It will be appreciated that child window module 252 is being described here as a representative child window module. The same features and functionality described with respect to child window module 242 may be present in any of child window modules 252-262, or in child window modules that are a part of, or used in conjunction with, systems other than GUI management module 118.

The implementation of child window module 252 shown in FIG. 3 includes, without limitation, a child window mode promotion/demotion sequence 308, a current mode indicator 310, child window presentation data 312, child window attribute data 314, and mode data 316.

Child window mode promotion/demotion sequence 308 specifies all available modes of the child window associated with child window module 252. For example, and without limitation, the example child window mode promotion/demotion sequence 310 shown in FIG. 3 indicates that the child window associated with child window module 252 has five possible modes: mode 1U, mode 2b, mode 3S, mode 5M and mode 6.

Child window mode promotion/demotion sequence 310 also specifies a promotion and demotion order of the modes of the child window, which are indicated in FIG. 3 by the arrowed lines extending between the various modes. For example, child window mode promotion/demotion sequence 310 indicates that if the child window associated with child window module 300 is currently in mode 2b, it may, in a single demotion, be demoted to mode 1U or in a single promotion be promoted to mode 3S. Likewise, if the child window associated with child window module 252 is currently in mode 5M, child window mode promotion/demotion sequence 310 indicates that the child window may, in a single demotion, be demoted to mode 3S, or, in a single promotion, be promoted to mode 6.

Current mode indicator 310 specifies the current mode of the child window associated with child window module 252. For example, the current mode indicator 310 shown in FIG. 3 indicates that the child window associated with child window module 252 is currently being displayed in accordance with mode 2b. When the mode of the child window associated with child window module 252 is promoted or demoted, current mode indicator 310 is then modified as appropriated to indicate the change.

Typically, although not necessarily, modes are ordered in child window mode sequence 252 according to how much display real estate each mode can or will require. In these implementations, a mode requiring a greater amount of display real estate would be considered a “higher ordered” mode than a mode requiring less display real estate. In some cases one or more modes may be variable in size. In such cases, the maximum sizes of the modes may be used in determining or specifying the relative ordering of the modes in a promotion/demotion sequence. For example, in some implementations, a first mode having a maximum variable size that is greater than the fixed or maximum variable size of second mode may be said to be higher ordered than the second mode.

Typically, although not necessarily, when changing a child window from one mode to another, the child window is then transitioned from its current mode to either the next higher or lower mode in its mode sequence, depending on whether more or less display real estate is required.

Child window presentation data 312 includes various data that defines the current size and position of the child window in child window presentation area 132. Child window attribute data 314 includes various data that is used in determining child window rankings, as described below. This data may include such things as, without limitation, when the child window was a focused window, how long the child window was a focused window, how often the child window was a focused window, or various other data.

Mode data 316 includes data that defines features and functionality of each mode of the child window. This data may include parameters that define, for each mode, such things as, the number and arrangement of window controls that are to be rendered, whether the child window is resizable, the maximum and/or minimum size of a resizable window, etc.

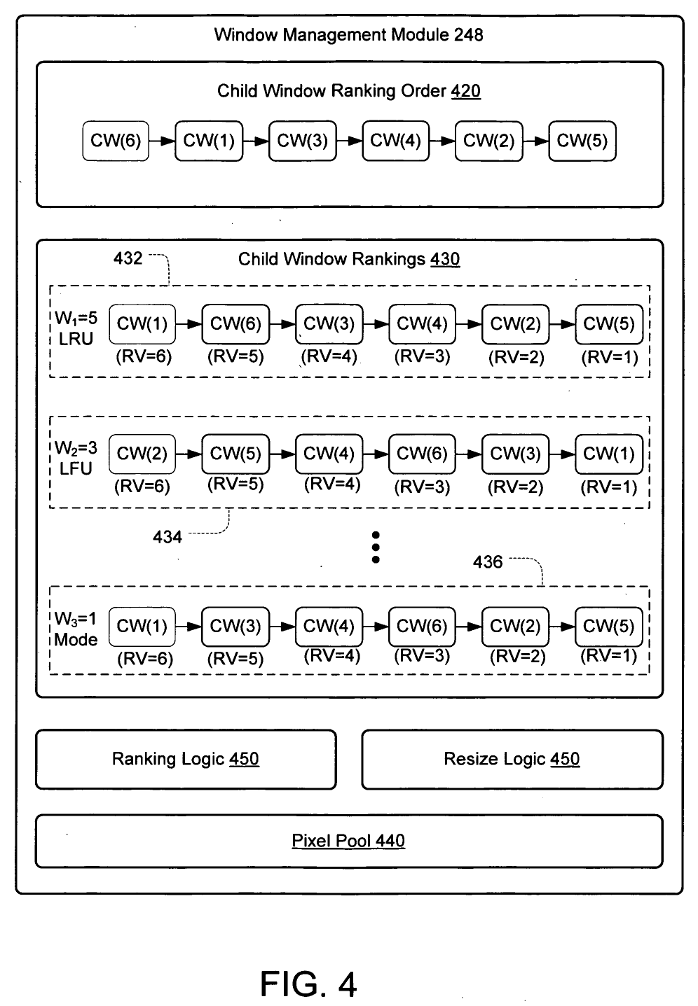

Mode data 316 may further specify whether a given mode is user selectable and/or system selectable. A user selectable mode (e.g., mode 1U) is a mode to which a child window can be promoted or demoted based on an action taken by a user interaction with computing device 100. In contrast, a system selectable mode (e.g., mode 3S) is a mode to which a child window cannot be promoted or demoted based solely on an action taken by a user interaction with computing device 100. Rather, a system selectable mode is a mode to which a child window is promoted or demoted based on instructions defined or implemented by resize logic 460 (described below with respect to FIG. 4).

In accordance with some implementations, the child window mode promotion/demotion sequence of each child window module is composed of a subset of a sequence of modes specified in a master mode promotion/demotion sequence. For example, child window mode promotion/demotion sequence 310 is composed of a subset of the modes of master mode master mode promotion/demotion sequence 320 illustrated in FIG. 3.

Child window modules may be implemented in a number of ways. For example, a child window module may be implemented as an object in an object-oriented environment and embodied in a computer-readable medium or media. However, it should be understood that the functionality described herein with respect to a child window module can also be implemented in a non-object-oriented fashion, and can be implemented on many types of systems, both object-oriented and non-object-oriented.

Turning now to FIG. 4, illustrated therein is an example implementation of window management module 248. Window management module 248 includes, without limitation, a child window ranking order 420, child window rankings 430, a pixel pool 440, ranking logic 450, and resize logic 460, each of which will now be described.

Child window ranking order 420 specifies an order of the displayed and hidden child windows. For example, the child windows 134-144 (CW(1)-CW(6)) are shown in child window ranking order 420. In general, child window ranking order 420 specifies an order in which child windows may be selected for mode change, such as when a mode change of one or more windows is required to maintain a display scheme.

The order of the child windows in child window ranking order 420 may be determined in various ways. For example, and without limitation, the order of the child windows in child window ranking order 420 may be determined according to a historical analysis of child window usage, a historical analysis of child window mode changes, or various other analyses, algorithms, and/or heuristics. The precise manner in which the order of child windows in child window ranking order 420 is determined may vary, depending on such things as, without limitation, the particular display scheme being adhered to, the computing device in which GUI 106 is employed, the intended use of computing device 100, and various other functional requirements.

In some implementations, child window ranking order 420 is determined using child window rankings 430. In general, child window rankings 430 comprise one or more rankings 432-436 of the child windows. As with child window ranking order 420, each child window ranking 432-436 may be determined in various ways using various analyses, algorithms, and/or heuristics.

As an example, child window ranking 432 is shown as being determined based on how recently each of the child windows has been used. More particularly, in this implementation, child window ranking 432 is ordered from the least recently used child window (CW(1)) to the most frequently used child window (CW(5)). In contrast, child window ranking 434 is shown as being determined based on frequency of use of the child windows. More particularly, in this implementation, child window ranking 434 is ordered from the least frequently used child window (CW(2)) to the most frequently used child window (CW(1)). In this implementation, child window ranking 436 is ordered based on the position of the current mode of each child window in its child window ranking order 308. As will be appreciated, child window rankings may be based on various other criteria.

In some implementations, each child window in a child window ranking is assigned a ranking value based on the child windows position in the ranking. As described below, these ranking values may be used in determining child window ranking order 420. In one implementation, ranking values are assigned to windows in the child window rankings in a descending order, from the first ranked window in a child window ranking to the last ranked window in a child window ranking. As an example, the first child window in each child window ranking of child window rankings 430 is shown as having a ranking value of 6 (i.e., RV=6), the second child window in each child window ranking is shown as having a ranking value of 5, and so on in a descending order down to the sixth child window in each child window ranking, which is shown as having a ranking value of 1. It will be appreciated that the ranking values shown and described with respect to FIG. 4 are illustrative only.

In some implementations, each child window ranking has an associated ranking weight. For example, child window ranking 432 is shown as having a weight of five (W₁=5), child window ranking 434 is shown as having a weight of three (W₂=3), and child window ranking 434 is shown as having a weight of one (W_{N}=1). It will be appreciated that the ranking weights shown and described with respect to FIG. 4 are illustrative only.

As described below, ranking weights may used in determining child window ranking order 420. The ranking weight associated with each child window ranking may be determined in various ways. For example, and without limitation, ranking weights may be determined using various analyses, algorithms, and/or heuristics. In some implementations, the ranking weight associated with each child window ranking is proportional to the relative importance of each child window ranking in determining child window ranking order 420.

Once determined, ranking weights may be static or dynamic. For example, in one implementation, ranking weights may be “hard coded.” In another implementation, the ranking weights may be predominantly fixed, but adjustable, such as by a user or administrator, or by a remote weight updating mechanism. In yet another implementation, the ranking weights may be dynamically adjusted by an algorithm that monitors various attributes of, and interactions with, GUI 106, computing device 100, and/or other attributes or interactions, within or external to the computing device 100.

As noted, in some implementations, the child window ranking order 420 is determined using ranking weights and/or ranking values. For example, and without limitation, in one implementation the child window ranking order 420 is determined by establishing a ranking score for each of the windows based on the ranking weights and the ranking values. The child window ranking order 420 is then determined by ordering the windows according to the ranking scores.

There are a number of ways in which the ranking weights and the ranking values may be used to establish ranking scores. For example, and without limitation, in one implementation a weighted ranking value is determined for each child window in each child window ranking by multiplying the ranking value of the child window by the ranking weight associated with the child window ranking including the child window. The ranking score of each child window would then be determined by summing the weighted ranking for the child window in each of the child window rankings.

For example, using the illustrative numbers presented in FIG. 4, CW1 in child window ranking 432 has a weighted ranking value of thirty (30), which is determined by multiplying CW(1)'s ranking value of six (6) in child window ranking 432 by the weight of five (5) of child window ranking 432. CW1 in child window ranking 434 has a weighted ranking value of three (3), which is determined by multiplying CW(1)'s ranking value of one (1) in child window ranking 434 by the weight of three (3) of the child window ranking 434. Finally, CW1 in child window ranking 436 has a weighted ranking value of six (6), which is determined by multiplying CW(1)'s ranking value of six (6) in child window ranking 436 by the weight of three (1) of the child window ranking 436. Finally, summing the weighted ranking values for CW1 for each of the child window rankings yields a ranking score for CW1 of thirty-nine (39) (i.e., 30+6+6=39).

Similar calculations can be made for each of the child windows, yielding a ranking score for CW2 of thirty (30), a ranking score for CW3 of thirty-four (34), a ranking score for CW4 of thirty (31), a ranking score for CW5 of fifteen (15), and a ranking score for CW6 of forty-four (44). Using these calculated ranking scores, the child windows are then arranged in child window ranking order 420 in descending order, according to their ranking scores.

In accordance with some implementations, all or a part of the determination of child window ranking order 420, child window rankings 430, the ranking weights, the ranking values, and/or the weighed ranking values may be carried out by ranking logic 450.

In accordance with some implementations, described in detail below, window management module 248 maintains a display scheme using pixel pool 440. In general, pixel pool 440 provides a mechanism for keeping track of display real estate within child window presentation area 122. More particularly, in some implementations, pixel pool 440 provides a mechanism for keeping track of the amount of display real estate within child window presentation area 122 that is allocated to child windows.

There are a number of ways in which allocation of display real estate may be tracked using pixel pool 440. For example, and without limitation, in one implementation, pixel pool 440 specifies whether the display real estate within child window presentation area 122 is “under allocated,” “over allocated,” or “balanced.” As used here, “under allocated” means that the display real estate allocated to the child windows is less than the total amount of display real estate within child window presentation area 122. As used here, “over allocated” means that the display real estate allocated to the child windows is greater than the total amount of display real estate within child window presentation area 122. In some implementations, pixel pool 440 may specify a quantity of under allocated display real estate or a quantity of over allocated display real estate. As used here, “balanced” means that the display real estate allocated to the child windows is equal to the total amount of display real estate within child window presentation area 122.

The units used with respect to pixel pool 440 to express display real estate may vary. For example, in some implementations the display real estate may be expressed in terms or pixels. In other implementations the display real estate may be expressed in terms of lines of pixels. Expressing display real estate in lines of pixels is particularly useful with respect to display scheme where the width and/or height of child window presentation area 122 remain constant. In other implementations, display real estate may be expressed in units unrelated to pixels. As such, while various implementations are described in terms of pixels or lines of pixels, it should be appreciated that such implementations may likewise be use units other than pixels or lines of pixels.

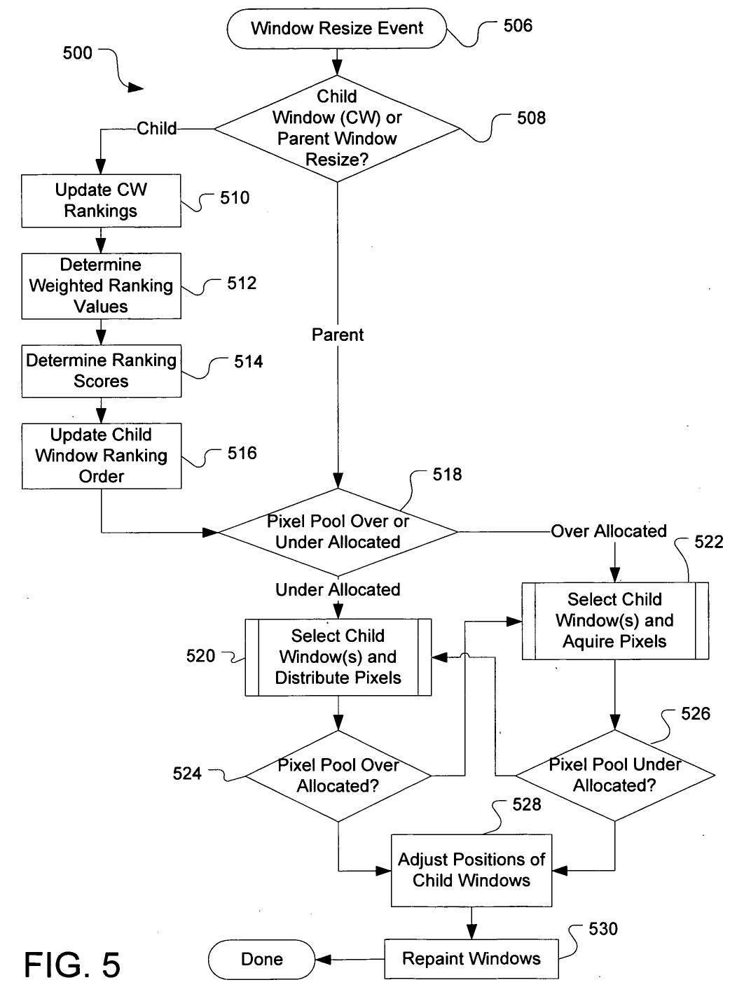

In accordance with some implementations, window management module 248 maintains a display scheme using resize logic 460. In general, resize logic 460 specifies various operations, algorithms, routines, etc., for maintaining a display scheme. For example, in accordance with some implementations, resize logic 460 implements all or part of the operational flows and operations illustrated in FIGS. 5-7, each of which will now be described.

FIG. 5-7 illustrates operational flows including various operations that may be carried out in managing and presenting a GUI. The following descriptions of FIGS. 5-7 are made with reference to computing device 100 of FIG. 1. In particular, the descriptions of FIGS. 5-7 are made with reference to GUI management module 118. However, it should be understood that the operational flows set forth in FIGS. 5-7 are not intended to be limited to being performed by GUI management module 118, or in computing device 100. Any of the operational flows set forth in FIGS. 5-7, or any individual operations described in these operational flows, may be implemented, in various other systems, including distributed systems. Additionally, it should be understood that while each of the operational flows illustrated in FIGS. 5-7 indicate a particular order of operation execution, in other implementations the operations may be ordered differently.

FIG. 5 illustrates an operational flow 500 including various operations that may be carried by window management module 248 in response to the detection or occurrence of a window resize event 506. In accordance with some implementations, operational flow 500 is defined and/or implemented by resize logic 460 (FIG. 4).

Generally, a window resize event may be any of various events that cause a request to be made to windowing sub-system 122 or GUI management module 118 for the change in size of a window. For example, and without limitation, in the case where parent window 130 or one of child windows 134-144 includes some sort of window resizing control, the user invocation of or interaction with that control may cause a window resize event. In another example, a child window mode change, caused either by user interaction or by GUI management module 118, may cause or request a change in size of a child window, thus causing a window resize event.

In accordance with some implementations, when a resize event occurs, pixel pool 440 will be updated to reflect the change in display real estate that will be caused by the resize event. In the cases where the resize event relates to resizing parent window 130, one or more parameters that define the size of parent window 130 in parent window module 250 will be updated to reflect the resize, and pixel pool 440 will be updated accordingly. In the case where the resize event relates to resizing a child window, one or more parameters that define the size of the child window in the child window module associated with the child window will be updated to reflect the resize, and pixel pool 440 will be updated accordingly. As described below, the actual resize of the child or parent window on display 104 will typically not occur at this point in operational flow 500. Rather, the actual resize the child or parent window on display 104 typically occurs below at repaint operation 526.

As shown, when a resize event occurs, a determination is made at operation 508 as to whether the window resize event relates to parent window 130 or to one of child windows 134-144. If it is determined that the window resize event relates to parent window 130, operational flow 500 proceeds to operation 518, described below. However, if it is determined at operation 508 that the window resize event relates to a child window 134-144, operational flow 500 proceeds to ranking update operation 510.

At ranking update operation 510, child window rankings 430 (FIG. 4) are updated according to whatever analyses, algorithms, and/or heuristics determines or defines rankings 432-436. Next, at weighted ranking values operation 512, weighted ranking values are determined for each child windows. Ranking scores are then determined for each of the child windows at ranking scores operation 514. Child ranking order 420 (FIG. 4) is then updated at ranking order operation 516 based on the ranking scores determined at ranking scores operation 516. Following order operation 516, operational flow 500 proceeds to operation 518.

In accordance with other implementations, operations 510-516 may occur outside of operational flow 500. For example, in some implementations, operations 510-516 may occur when the size of a child window has been changed, such as when the child window is resized or the mode of the child window has been changed. In other implementations, operations 510-516 may occur at periodic intervals, regardless of, or in addition to, the determination at operation 508 that a resize event has occurred with respect to parent window 130 or a child window 134-144. In other implementations, the execution of operations 510-516 may be triggered by some other event or schedule.

At operation 518, a determination is made as to whether pixels are over allocated or under allocated in pixel pool 440. If it is determined that pixels are under allocated in pixel pool 400, operational flow 500 proceeds to distribute pixel operation 520, described below. If it is determined that pixels are over allocated in pixel pool 400, operational flow 500 proceeds to acquire pixel operation 522, described below.

At distribute pixel operation 520, various operations are performed to select one or more child windows to receive the over allocated pixels, and to allocate the pixels to the selected windows. Stated another way, at operation 520, one or more child windows are selected to have their size(s) increased, and pixels are taken from pixel pool 440 to accommodate the increase.

As described above, in accordance with some implementations, increasing the size of a selected child window comprises increasing one or more parameters that define the size of the selected child window in child window presentation data 312 (FIG. 3) of the selected child window module.

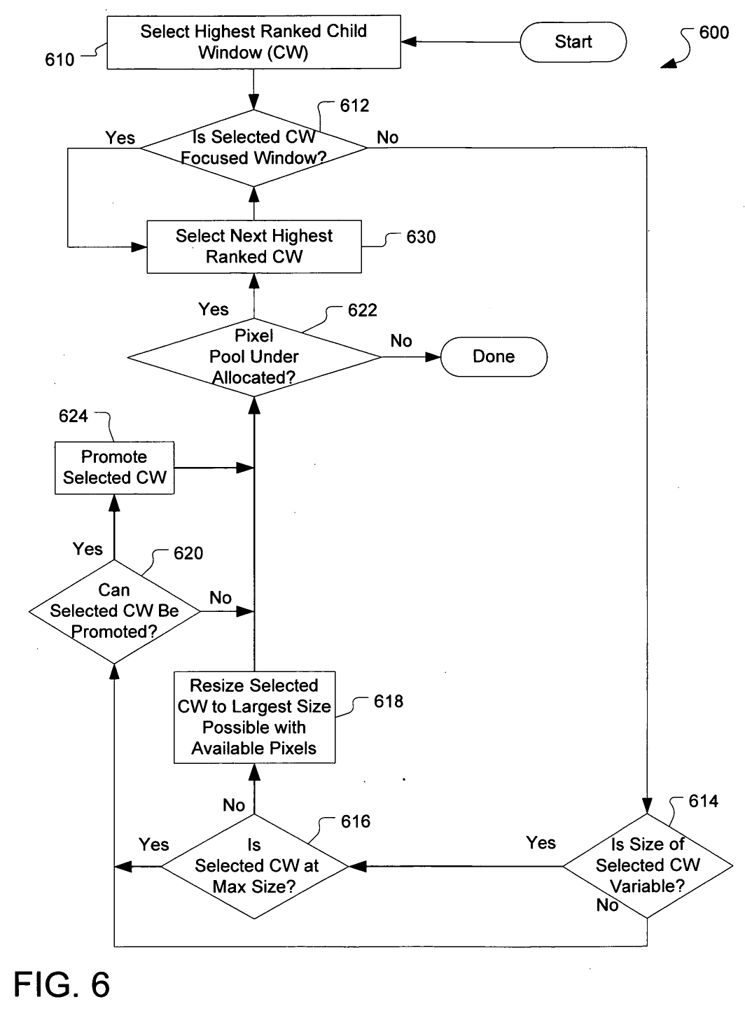

Distribute pixel operation 520 may be carried out in a number of ways. The precise manner in which distribute pixel operation 520 is carried out may be dependent on such things as, without limitation, the particular display scheme being used and the particular programmatic/hardware environment and implementation of GUI management module 118. However, in one implementation, distribute pixel operation 520 is implemented in accordance with operational flow 600, described below with respect to FIG. 6.

Following distribute pixel operation 520, a determination is made at operation 524 as to whether pixel pool 440 is over allocated. If it is determined at operation 524 that pixel pool 440 is over allocated, operational flow 500 proceeds to acquire pixel operation 522. If it is determined at operation 524 that pixel pool 440 is not over allocated, operational flow 500 proceeds to adjust operation 524, described below.

At acquire pixel operation 522, various operations are performed to select one or more child windows from which to acquire the under allocated pixels, and to acquire the pixels for pixel pool 440. Stated another way, at operation 522, one or more child windows are selected to have their size(s) decreased, and the pixels are taken from selected child windows and given to the pixel pool.

As described above, in accordance with some implementations, decreasing the size of a selected child window comprises decreasing one or more parameters that define the size of the selected child window in the child window presentation data 312 of the selected child window module.

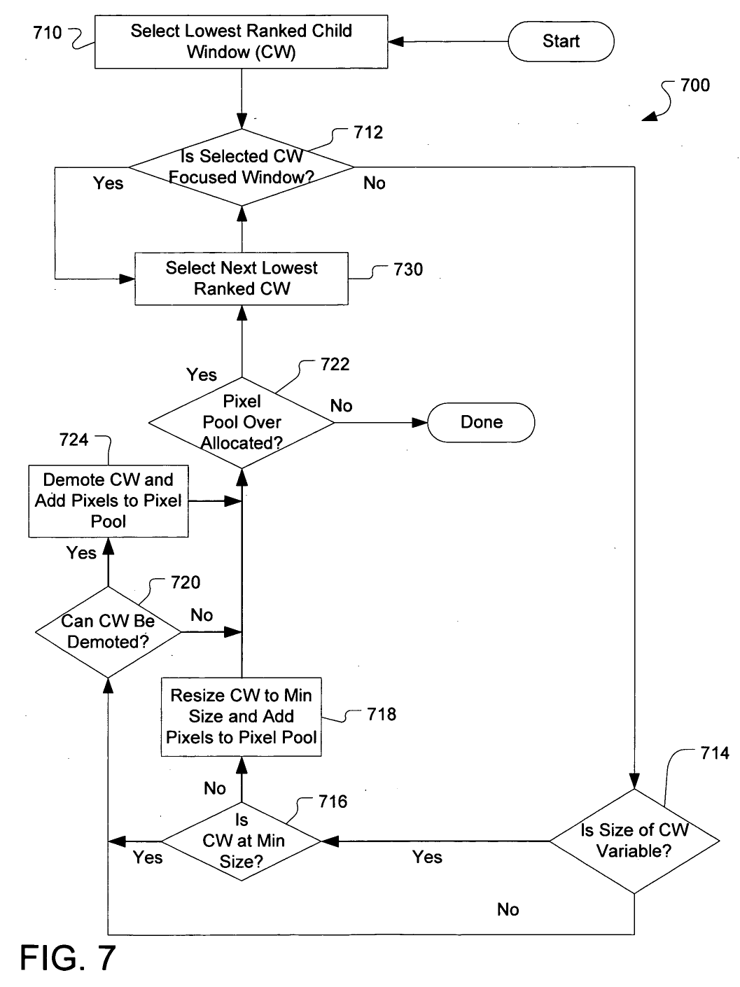

Acquire pixel operation 522 may be carried out in a number of ways. The precise manner in which acquire pixel operation 522 is carried out may be dependent on such things as, without limitation, the particular display scheme being used and the particular programmatic/hardware environment and implementation of GUI management module 118. However, in one implementation, acquire pixel operation 522 is implemented in accordance with operational flow 700, described below with respect to FIG. 7.

Following acquire pixel operation 522, a determination is made at operation 526 as to whether pixel pool 440 is under allocated. If it is determined at operation 526 that pixel pool 440 is under allocated, operational flow 500 proceeds to distribute pixel operation 520, described above. If it is determined at operation 526 that pixel pool 440 is not under allocated, operational flow 500 proceeds to adjust operation 524, described below.

At adjust operation 524, the positions of all child windows 134-144 are adjusted. In some implementations, adjusting the position of a child window comprises changing one or more parameters that define the position of the child window in child window presentation data 312 (FIG. 3) of child window module 252 (FIG. 2) associated with the child window.

Following adjust operation 524, all of the child windows are repainted in child window presentation area 132, and operational flow 500 ends.

Turning now to FIG. 6, as previously described, shown therein is an operational flow 600 including various operations that may be carried out in implementing distribute pixel operation 520 of operational flow 500. In accordance with some implementations, operational flow 500 is defined and/or implemented by resize logic 460 (FIG. 4).

As shown, at the start of operational flow 600, a child window selection operation 610 selects the child window having the highest rank in child window ranking order 420 (FIG. 4). Next, at operation 612, a determination is made as to whether the selected child window is the focused child window. As used here, the focused child window is a child window that is active to receive user input. In accordance with the implementation of distribute pixel operation 520 shown in FIG. 6, only one child window will be active to receive user input at a time. Hence, only one user window at a time will a focused child window.

In some implementations, the determination as to whether the selected child window is the focused child window is made by querying the windowing sub-system 122. In some implementations, this determination is made by examining a focus attribute in child window attribute data 314 of the selected window. In other implementations, the determination as to whether the selected child window is the focused child window may be made in other ways.

If it is determined at operation 612 that the selected child window is the focused window, operational flow 600 proceeds to child window selection operation 630, where the child window having the next highest rank in child window ranking order 420 is selected. Stated another way, at operation 630, child window ranking order 420 is examined and the next highest ranked child window above the child window previously selected in operational flow 600 is selected. It should be understood that only one child window is selected at a time. As such, when a new child window is selected, the child window that was previously selected is no longer considered the selected child window.

However, if is determined at operation 612 that the selected child window is the not the focused window, operational flow 600 proceeds to operation 614. At operation 614, a determination is made as to whether the current mode of the selected child window specifies that the child window is variable in size. Stated another way, a determination is made as to whether the size of the selected child window is variable in its current mode. In one implementation, this determination is made by examining a size attribute in mode data 316 of the child window module associated with the selected window.

If it is determined that the size of the selected child window is variable in its current mode, operational flow 600 proceeds to operation 616, described below. However, if it is determined at operation 614 that the size of the selected child window is not variable in its current mode, operational flow 600 proceeds to operation 620, described below.

At operation 616, a determination is made as to whether the selected child window is at the maximum of its variable size. In one implementation, this determination is made by examining a size attribute in mode data 316 of the child window module associated with the selected window. If it is determined at operation 616 that the selected child window is not at the maximum of its variable size, operational flow 600 proceeds to resize operation 618, described below. If it is determined at operation 616 that the selected child window is at the maximum of its variable size, operational flow 600 proceeds to operation 620, described below.

At resize operation 618, pixel pool 440 is examined to determine the amount of the under allocated pixels therein. If the amount of under allocated pixels is equal to or greater than the number pixels required to increase the size of the selected child window to the maximum of its variable size, the size of the selected child window is increased to the maximum of its variable size. If, however, the amount of under allocated pixels is less than the number pixels required to increase the size of the selected child window to the maximum of its variable size, the size of the selected child window is increased to the maximum amount permissible by the available under allocated pixels. In some implementations, any or all of operations 510-516 described above with respect to FIG. 5 may be performed following or in conjunction with the resize of child window. Following resize operation 618, operational flow 600 proceeds to operation 622, described below.

At operation 620, a determination is made as to whether the selected child window can be promoted to another mode. That is, a determination is made as to whether the selected child window can be promoted to a higher order mode requiring more display real estate than the current mode of the selected window. If it is determined at operation 620 that the selected child window can not be promoted to a higher order mode, the operational flow proceeds to operation 622. If it is determined at operation 620 that the selected child window can not be promoted to a higher order mode, the operational flow proceeds to promotion operation 624.

At promotion operation 624, the selected child window is promoted to its next highest ordered mode in the promotion/demotion sequence 308 of the selected child window. In some implementations, promoting the selected child window to its next highest mode comprises changing current mode indicator 310 in the child window module associated with the selected window, changing the appropriate size attributes in child window presentation data 312, and updating pixel pool 440 to reflect the amount of pixels allocated to the selected child window. In some implementations, any or all of operations 510-516 described above with respect to FIG. 5 may be performed following or in conjunction with the promotion of the selected child window. It should be appreciated that, following promotion operation 624, pixel pool 440 may remain under allocated, or it may be over allocated. Following promotion operation 624, operational flow 600 proceeds to operation 622.

At operation 622, a determination is made as to whether pixel pool is under allocated. If it is determined that pixel pool 440 is under allocated, operational flow 600 proceeds to child window selection operation 630, described above. If it is determined that pixel pool 440 is not under allocated, operational flow 600 ends.

Turning now to FIG. 7, as previously described, shown therein is an operational flow 700 including various operations that may be carried out in implementing acquire pixel operation 522 of operational flow 500. In accordance with some implementations, operational flow 500 is defined and/or implemented by resize logic 460 (FIG. 4).

As shown, at the start of operational flow 700, a child window selection operation 710 selects the child window having the lowest rank in child window ranking order 420 (FIG. 4). Next, at operation 712, a determination is made as to whether the selected child window is the focused child window.

If it is determined at operation 712 that the selected child window is the focused window, operational flow 700 proceeds to child window selection operation 730, where the child window having the next lowest rank in child window ranking order 420 is selected. However, if is determined that the selected child window is the not the focused window, the operational flow proceeds to operation 714.

At operation 714, a determination is made as to whether the current mode of the selected child window specifies that the child window is variable in size. In one implementation, this determination is made by examining a size attribute in the mode data 316 of the child window module associated with the selected window.

If it is determined at operation 714 that the size of the selected child window is variable in its current mode, operational flow 700 proceeds to operation 716. However, if it is determined at operation 714 that the size of the selected child window is not variable in its current mode, operational flow 700 proceeds to operation 720.

At operation 716, a determination is made as to whether the selected child window is at the maximum of its variable size. In one implementation, this determination is made by examining a size attribute in the mode data 316 of the child window module associated with the selected window. If it is determined at operation 716 that the selected child window is not at the maximum of its variable size, operational flow 700 proceeds to resize operation 718. If it is determined at operation 716 that the selected child window is at the maximum of its variable size, operational flow 700 proceeds to operation 720.

At resize operation 718, the size of the selected child window is decreased to its minimum variable size. In some implementations, any or all of operations 510-516 described above with respect to FIG. 5 may be performed following or in conjunction with the resize of the selected child window. Following resize operation 718, operational flow 700 proceeds to operation 722, described below.

At operation 720, a determination is made as to whether the selected child window can be demoted to another mode. That is, a determination is made as to whether the selected child window can be promoted to a lower order mode requiring less display real estate than the current mode of the selected window. If it is determined at operation 720 that the selected child window can not be promoted to a lower order mode, operational flow 700 proceeds to operation 722. If it is determined at operation 720 that the selected child window can be demoted to a lower order mode, the operational flow proceeds to demotion operation 724, where the selected child window is demoted to its next lowest ordered mode in the promotion/demotion sequence 308.

In some implementations, demoting the selected child window to its next lowest order mode comprises changing current mode indicator 310 in the child window module associated with the selected window, changing the appropriate size attributes in child window presentation data 312, and updating pixel pool 440 to reflect the amount of pixels acquired from to the selected child window. In some implementations, any or all of operations 510-516 described above with respect to FIG. 5 may be performed following or in conjunction with the demotion of the selected child window. It should be appreciated that, following promotion operation 724, pixel pool 440 may remain over allocated, or it may be under allocated.

At operation 722, a determination is made as to whether pixel pool is over allocated. If it is determined that pixel pool 440 is over allocated, operational flow 700 proceeds to child window selection operation 730, described above. If it is determined that pixel pool 440 is not over allocated, operational flow 700 ends.

Although some particular example implementations have been illustrated in the accompanying drawings and described in the foregoing Detailed Description, it will be understood that the subject matter described herein is not limited to the particular implementations described. Rather, the subject matter described herein is capable of numerous rearrangements, modifications and substitutions without departing from the spirit set forth and defined by the following claims. Accordingly, the scope of the present invention should not be limited by the particular example implementations discussed above, but should be defined only by the claims set forth below and equivalents thereof.

What is claimed is:

1. A method, comprising:
displaying a plurality of child windows in a parent window in accordance with a display scheme, each child window being displayable in one mode of a group of ordered modes associated with the child window, each mode specifying a display size for the child window with which it is associated; and
in response to a change in the display size of a first child window of the plurality of child windows, changing the mode of a second child window of the plurality of child windows so as to maintain the predetermined display scheme.

2. The method of claim 1, wherein changing the mode of a second child window comprises accessing a pixel pool, the pixel pool indicating a total amount of display real estate within the parent window allocated to the child windows.

3. The method of claim 1, wherein the modes in each group of modes are ordered in a child window promotion/demotion sequence.

4. The method of claim 1, wherein the modes of the second child window are ordered in a child window promotion/demotion sequence and wherein changing the mode of at least the second of the child windows is carried out based on the child window promotion/demotion sequence.

5. The method of claim 1, wherein each group of modes includes a subset of modes of a master mode promotion/demotion sequence.

6. The method of claim 1, wherein each mode further specifies windows controls for the child window with which it is associated.

7. The method of claim 1, wherein displaying a plurality of child windows in a parent window in accordance with a display scheme comprises displaying all of the child windows such that the child windows collectively occupy a predetermined portion of the parent window and such that no child window overlaps another child window.

8. One or more computer-readable media embodying processor-executable instructions that, when executed by one or more processors, implement a method comprising:
presenting a graphical user interface (GUI) on a display, the GUI comprising visual elements including a parent window and a plurality of child windows within the parent window, each child window being displayed in one visual mode of a plurality of visual modes associated with the child window, each child window being ranked relative to the other child windows in a child window ranking order; and
in response to a change in a display size of one of the visual elements, changing a display size of one of the child windows based on the child window ranking order and a pixel pool indicating an amount of display real estate allocated to the child windows.

9. The one or more computer-readable media of claim 8, wherein the child window ranking order is determined based on frequency of use of the child windows.

10. The one or more computer-readable media of claim 8, wherein the child window ranking order is determined based on times of use of the child windows.

11. The one or more computer-readable media of claim 8, wherein the child window ranking order is determined based on a plurality of child window rankings.

12. The one or more computer-readable media of claim 8, wherein the child window ranking order is determined based on a plurality of weighted child window rankings.

13. The one or more computer-readable media of claim 8, wherein changing a display size of one of the child windows comprises changing the mode of the one of the child windows.

14. The one or more computer-readable media of claim 8, wherein the plurality of visual modes associated with each child window is ordered in a promotion/demotion sequence.

15. A system comprising:
a computing device including a display;
means for presenting a graphical user interface (GUI) on the display, the GUI comprising visual elements including a parent window and a plurality of child windows within the parent window, each child window being displayed in one visual mode of a plurality of visual modes associated with the child window; and
means for changing, in response to a change in a display size of one of the visual elements, the size of a child window based on a ranking order of the child windows.

16. The system of claim 15, wherein the means for presenting the GUI comprises a plurality of child window modules, each child window module specifying a promotion/demotion sequence of the modes associated with the child window module.

17. The system of claim 15, wherein the means for presenting the GUI comprises a plurality of child window modules, each child window module specifying whether the child window associated therewith is variable in size.

18. The system of claim 15, wherein the means for changing comprises a window management module including a child window ranking order specifying an ordering of the child windows.

19. The system of claim 15, wherein the means for changing comprises a window management module including a child window ranking order and a plurality of child window rankings, each child window ranking specifying a unique ordering of the child windows based on some criteria, the child window ranking order specifying an ordering of the child windows based on the child window rankings.

20. The system of claim 15, wherein the means for changing comprises a window management module including a child window ranking order, a plurality of child window rankings, and a pixel pool, each child window ranking specifying a unique ordering of the child windows based on some criteria, the child window ranking order specifying an ordering of the child windows based on the child window rankings, the pixel pool specifying an amount of display real estate allocated to the child windows.
